(19) United States
(12) Patent Application Publication
(10) Pub. No.: US 2009/0037385 A1
(43) Pub. Date: Feb. 5, 2009

(54) APPARATUS AND METHOD FOR TRANSMITTING CONTENTS BETWEEN PORTABLE TERMINALS

(75) Inventors: Byung-Jo MIN, Suwon-si (KR); Wook-Hyun JEONG, Suwon-si (KR); Soo-Jin PARK, Suwon-si (KR)

Correspondence Address: Jefferson IP Law, LLP, 1730 M Street, NW, Suite 807, Washington, DC, 20036, US

(73) Assignee: Samsung Electronics Co., Ltd., Suwon-si (KR)

(21) Appl. No.: 12/184,369

(22) Filed: Aug. 1, 2008

(30) Foreign Application Priority Data
Aug. 1, 2007 (KR) 2007-0077347

(51) Int. Cl. G06F 7/06; G06F 17/30

(52) U.S. Cl. 707/3; 707/10; 707/E17.005; 707/E17.014

(57) ABSTRACT

An apparatus and method for transmitting one or more contents through a short-range communication is provided. The apparatus includes a content-requesting terminal and a content-providing terminal. The content-requesting terminal requests a list of contents available for transmission to the content-providing terminal, receives the content list from the content-providing terminal, selects one or more contents from the content list, and receives the selected one or more contents from the content-providing terminal. The content-providing portable terminal receives a request for transmitting one or more contents selected from the content list from the content-requesting terminal, and transmits the requested one or more contents to the content-requesting terminal.

### PRIORITY

This application claims the benefit under 35 U.S.C. §119(a) of a Korean patent application filed in the Korean Intellectual Property Office on Aug. 1, 2007 and assigned Serial No. 2007-77347, the entire disclosure of which is hereby incorporated by reference.

### BACKGROUND OF THE INVENTION

1. Field of the Invention

The present invention relates to an apparatus and method for transmitting contents between portable terminals. More particularly, the present invention relates to an apparatus and method for enabling a first portable terminal to search for and select contents in a second portable terminal and to receive the selected contents from the second portable terminal through a short-range communication.

2. Description of the Related Art

Research is being conducted on Digital Rights Management (DRM), and DRM-based commercial services have been introduced or are under development. DRM is a technology for protecting digital contents that are easy to copy and distribute without permission.

DRM technology classifies contents into Forward Lock (FL) service contents, Combined Delivery (CD) service contents, and Separate Delivery (SD) service contents. The FL service restricts transmission of contents. The CD service provides encrypted contents and a Right Object (RO) (i.e., a type of license), which includes information about decryption/reproduction conditions of the encrypted contents, in a combined manner. The SD service provides encrypted contents and a RO, which is used to decrypt the encrypted contents, in a separate manner. The use of the SD service makes it possible to download encrypted contents and then reproduce the contents by receiving a RO by means of a Wireless Application Protocol (WAP) push technology. This RO contains information about how many times or until when the corresponding contents can be reproduced. A user cannot reproduce downloaded DRM contents before receiving the RO. The reason for this is that the contents are encrypted by a key value contained in the RO.

DRM contents of the SD service are also called DRM Content Format (DCF), and a Right Issuer URL (RI URL) value is included in the contents. Thus, a user can request and receive a new RO through the RI URL, when the right for DRM contents expires. If a user attempts to execute the expired DCF, a portable terminal displays a user message indicating that the corresponding contents expired and solicits whether or not to retrieve a new RO. If the user agrees to retrieve a new RO, the portable terminal uses a browser to connect to a destination capable of providing the new RO. This process is called a reactivation process. In the Open Mobile Alliance (OMA) DRM v1.0, a terminal user A attaches a downloaded DCF file to, for example, a Multimedia Messaging Service (MMS) message, or transmits a downloaded DCF file to a terminal user B through a short-range communication network (or Wireless Personal Area Network (WPAN)) such as BlueTooth (BT), OBject EXchange (OBEX) File Transfer Protocol (FTP), and Infrared Data Association (IrDA), and the terminal user B receives the DCF file from the terminal user A and reproduces the DCF file through the above reactivation process. This transmission scheme is called a superdistribution scheme. According to the superdistribution scheme, the terminal user B can reproduce the corresponding content file only by receiving the corresponding RO through a constant payment. Therefore, through the superdistribution scheme, the mobile communication provider does not suffer a monetary loss, the terminal user A can distribute contents to other people without legal infringement, and the terminal user B can store desired contents in his own terminal without spending the time to search for contents and without paying a packet fee.

However, according to a superdistribution model proposed in the conventional OMA DRM standard, a terminal user A having a DCF file in his own terminal unilaterally transmits the DCF file to a terminal user B through various channels, thus causing the terminal user B to receive undesired contents.

In the above case, the DCF contents are actually received/displayed by the terminal user B. What is therefore needed is a transmitting apparatus and method that can distribute contents more conveniently by enabling the terminal user B to download selected contents by directly searching for a DCF file of the terminal user A and detecting various metadata and basic information supported in the DCF file.

### SUMMARY OF THE INVENTION

An aspect of the present invention is to address at least the above-mentioned problems and/or disadvantages and to provide at least the advantages below. Accordingly, an aspect of the present invention is to provide an apparatus and method for transmitting contents between portable terminals.

Another aspect of the present invention is to provide an apparatus and method for enabling a first portable terminal to search for and select contents in a second portable terminal and to receive the selected contents from the second portable terminal through a short-range communication.

Still another aspect of the present invention is to provide an apparatus and method for enabling a first portable terminal to search for contents in a second portable terminal, detect metadata of the contents, select contents and receive the selected contents from the second portable terminal through a short-range communication.

Even another aspect of the present invention is to provide an apparatus and method for enabling a first portable terminal to provide, upon receipt of a content search request from a second portable terminal, a transmittable content list to the second portable terminal, and for transmitting selected contents to the second portable terminal through a short-range communication.

According to one aspect of the present invention, a system for transmitting one or more contents through a short-range communication is provided. The system includes a content-requesting terminal for requesting a list of contents available for transmission to a content-providing terminal, for receiving the content list from the content-providing terminal, for selecting one or more contents from the content list, and for receiving the selected one or more contents from the content-providing terminal, and the content-providing terminal for receiving a request for a content list from the content-requesting terminal, for transmitting a list of contents available for transmission to the content-requesting terminal, for receiving a request for transmitting one or more contents selected from the content list from the content-requesting terminal, and for transmitting the requested one or more contents to the content-requesting terminal.

According to another aspect of the present invention, a portable terminal for requesting one or more contents is provided. The terminal includes a short-range communication unit for establishing short-range communication with a content-providing terminal, for transmitting a content list request message to the content-providing terminal, and for receiving a content list from the content-providing terminal, a display unit for displaying the content list, and a content list request unit for performing at least one control operation for transmitting the content list request message for requesting a list of contents available for transmission to the content-providing terminal, and for displaying the received content list on the display unit.

According to still another aspect of the present invention, a portable terminal for providing one or more contents is provided. The terminal includes a short-range communication unit for establishing a short-range communication with a content-requesting terminal, for receiving a content list request message from the content-requesting terminal, and for transmitting a content list to the content-requesting terminal, a memory unit for storing one or more contents, and a content list response unit for performing at least one control operation for receiving a request for a content list from the content-requesting terminal, for searching the memory unit for contents available for transmission, and for transmitting a list of the contents available for transmission to the content-requesting terminal.

According to even another aspect of the present invention, a method for requesting one or more contents by a portable terminal is provided. The method includes establishing short-range communication with a content-providing terminal and transmitting a request for a list of contents available for transmission to the content-providing terminal, and receiving a content list of one or more contents available for transmission from the content-providing terminal.

According to yet another aspect of the present invention, a method for providing one or more contents by a portable terminal is provided. The method includes establishing a short-range communication with a content-requesting terminal and receiving a request for a content list from the content-requesting terminal, searching for contents available for transmission, and transmitting a list of the contents available for transmission to the content-requesting terminal.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following description taken in conjunction with the accompanying drawings, in which:

FIG. 1 is a block diagram of a short-range communication system for searching for and selecting contents and for transmitting/receiving selected contents according to an exemplary embodiment of the present invention;

FIG. 2 is a flow diagram illustrating message flows between portable terminals for transmission of contents according to an exemplary embodiment of the present invention;

FIG. 3 is a flowchart illustrating a process for a portable terminal to search for and select contents and for receiving selected contents according to an exemplary embodiment of the present invention; and

FIG. 4 is a flowchart illustrating a process for a portable terminal to provide a content list and transmit selected contents according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions are omitted for clarity and conciseness.

Exemplary embodiments of the present invention are indented to provide an apparatus and method for enabling portable terminals to search for and select contents and to transmit/receive the selected contents through a short-range communication.

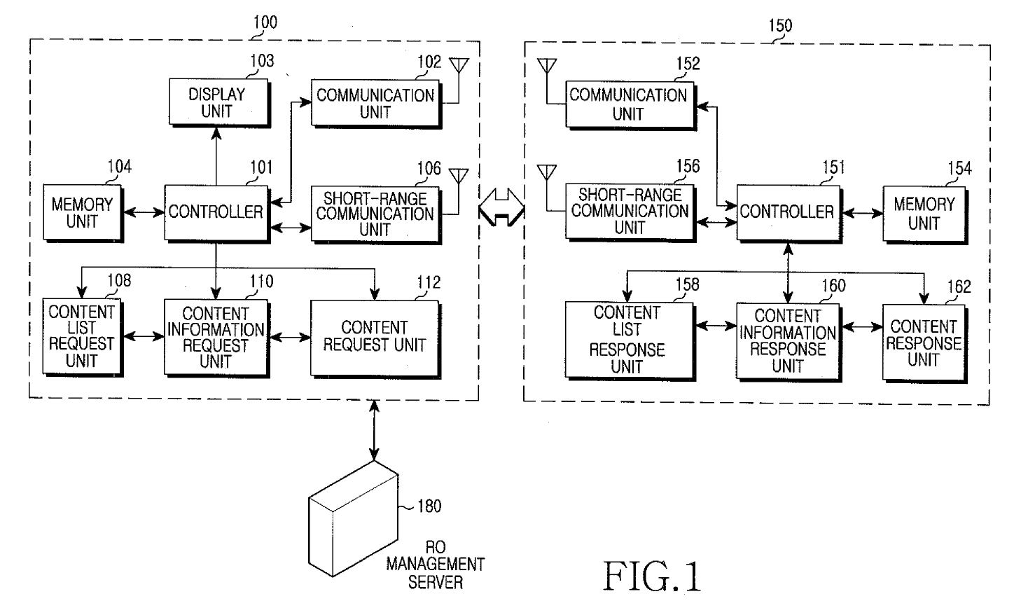

FIG. 1 is a block diagram of a short-range communication system for searching for and selecting contents and for transmitting/receiving selected contents according to an exemplary embodiment of the present invention.

Referring to FIG. 1, the communication system includes a content-requesting portable terminal 100, a content-providing portable terminal 150, and a Right Object (RO) management server 180.

The content-requesting portable terminal 100 includes a controller 101, a communication unit 102, a display unit 103, a memory unit 104, a short-range communication unit 106, a content list request unit 108, a content information request unit 110, and a content request unit 112.

For a reception (RX) operation, the communication unit 102 receives a Radio Frequency (RF) signal through an antenna, down-converts the received RF signal into a baseband signal, and despreads/channel-decodes the baseband signal. For a transmission (TX) operation, the communication unit 102 channel-codes/spreads TX data, up-converts the resulting baseband signal into an RF signal, and transmits the RF signal through the antenna. According to an exemplary embodiment the present invention, if an RO of contents is necessary, the communication unit 102 communicates with the RO management server 180 to receive the RO of the contents. The RO management server 180 sells or provides ROs for contents.

The display unit 103 displays a limited number of characters, moving pictures, still pictures, and state information (or indicators) that are generated during the operation of the content-requesting portable terminal 100. The display unit 103 may be implemented using a color liquid crystal display (LCD) or the like. According to an exemplary embodiment of the present invention, the display unit 103 displays a content list and content information that are received under the control of the controller 101.

The memory unit 104 stores a program for control of overall operations of the content-requesting portable terminal 100, application programs, and updatable data (e.g., phone numbers, SMS messages, compressed image files, moving pictures and the like). According to an exemplary embodiment of the present invention, the memory unit 104 stores received contents, content-related information, and ROs for contents.

The short-range communication unit 106 transmits/receives data and control signals in short-range communication with the content-providing portable terminal 150. According to an exemplary embodiment of the present invention, under the control of the controller 101, the short-range communication unit 106 transmits a content list request message or a content information request message, receives the corresponding response message, transmits a content request message, and receives the corresponding contents. Examples of a communication scheme for the short-range communication unit 106 include a Bluetooth communication scheme and an infrared communication scheme. In another exemplary embodiment, the short-range communication unit 106 may be any communication unit that enables peer-to-pear (P2P) communications. Further, while the communication unit 102 and the short-range communication unit 106 are illustrated and described as two separate units, they may be implemented as a single communication unit.

Upon detecting a content search event, the content list request unit 108 establishes a short-range communication through the short-range communication unit 106, generates a content list request message, and transmits the content list request message to the content-providing portable terminal 150, under the control of the controller 101. Upon receiving a content list from the content-providing portable terminal 150, the content list request unit 108 displays the content list on the display unit 103 under the control of the controller 101.

Upon receiving information corresponding to contents selected by a user from the content list, the content information request unit 110 requests the content-providing portable terminal 150 to transmit the selected content information, under the control of the controller 101. Upon receiving the selected content information from the content-providing portable terminal 150, the content information request unit 110 displays the received content information on the display unit 103 under the control of the controller 101.

Upon receiving a contents selection by the user from the content list, the content request unit 112 requests the content-providing portable terminal 150 to transmit the selected contents, under the control of the controller 101. Upon receiving the selected contents from the content-providing portable terminal 150, the content request unit 112 stores the received contents in the memory unit 104 under the control of the controller 101. Thereafter, if the received contents include contents that require a Right Object (RO), the content-requesting portable terminal 100 detects a Right Issuer Uniform Resource Locator (RI URL) from the received contents and communicates with the RO management server 180 to receive the RO of the received contents.

The controller 101 controls the content list request unit 108, the content information request unit 110, and the content request unit 112. The controller 101 may perform the functions of the content list request unit 108, the content information request unit 110, and the content request unit 112. Although separate units are illustrated and described for the respective functions of the controller 101, the controller 101 may perform all or some of the respective functions on behalf of the separate units.

The content-providing portable terminal 150 includes a controller 151, a communication unit 152, a memory unit 154, a short-range communication unit 156, a content list response unit 158, a content information response unit 160, and a content response unit 162.

For an RX operation, the communication unit 152 receives an RF signal through an antenna, down-converts the received RF signal into a baseband signal, and despreads/channel-decodes the baseband signal. For a TX operation, the communication unit 152 channel-codes/spreads TX data, up-converts the resulting baseband signal into an RF signal, and transmits the RF signal through the antenna. According to an exemplary embodiment of the present invention, if an RO for contents is needed, the communication unit 152 communicates with the RO management server 180, which sells or provides ROs for contents, to receive the RO for the contents.

The memory unit 154 stores a program for control of overall operations of the content-providing portable terminal 150, application programs, and updatable data (e.g., phone numbers, SMS messages, compressed image files, and moving pictures). According to an exemplary embodiment of the present invention, the memory unit 154 stores received contents, content-related information, and ROs for contents.

The short-range communication unit 156 transmits/receives data and control signals in short-range communication with the content-requesting portable terminal 100. According to an exemplary embodiment of the present invention, under the control of the controller 151, the short-range communication unit 156 receives a content list request message or a content information request message to transmit the corresponding response message, and receives a content request message to transmit the corresponding contents. Examples of the communication scheme for the short-range communication unit 156 include a Bluetooth communication scheme and an infrared communication scheme. In another exemplary, embodiment the short-range communication unit 156 may be any communication unit that enables peer-to-pear (P2P) communications. Further, while the communication unit 152 and the short-range communication unit 156 are illustrated and described as two separate units, they may be implemented as a single communication unit.

Under the control of the controller 151, the content list response unit 158 establishes short-range communication through the short-range communication unit 156 at a request for short-range communication establishment. Thereafter, upon receiving a content list request, the content list response unit 158 searches the memory unit 154 for contents available for transmission to generate a content list, and transmits the content list to the content-requesting portable terminal 100.

Herein, the contents available for transmission include contents that the user allows to be transmitted, among Combined Delivery (CD) service contents, non-FL (Forward Lock) contents, and Separate Delivery (SD) service contents.

Thereafter, upon receiving a content information request for selected contents from the content-requesting portable terminal 100, the content information response unit 160 searches the memory unit 154 for basic data and metadata of the selected contents to detect the requested content data, and transmits the detected content data to the content-requesting portable terminal 100.

Among the content data, the SD service contents include various metadata in a file, the types of which are shown in Table 1. This is described in detail in OMA-Download-DRMCF-V1_{—}0, the entire disclosure of which is hereby incorporated by reference.

TABLE 1

| Field name | Type | Purpose |
|---|---|---|
| Version | Uint8 | Version number |
| ContentTypeLen | Uint8 | Length of the ContentType field |
| ContentURILen | Uint8 | Length of the ContentURI field |
| ContentType | ContentTypeLen | The MIME media type of the |
| | octets | plaintext data |
| ContentURI | ContentURILen | The unique identifier of this |
| | octets | content object |
| HeadersLen | Uintvar | Length of the Headers field |
| DataLen | Uintvar | Length of the Data field |
| Headers | HeadersLen | Headers define additional metadata |
| | octets | about this content object |
| Data | DataLen octets | The encrypted data |

Also, among the content data, there are metadata of ID3 tab, user data box, etc, that are supported in the content format standards of 3gp, mp4, mp3, etc., which support Album Name, Musical Genre, Copyright Notice, Recording Year, Extra Info, Track number, Explicit Content Advisory, etc. and can be detected using a codec. This is described in detail in 3GPP TS 26.244 V7.1.0, the entire disclosure of which is hereby incorporated by reference.

Upon receiving a request for contents selected from the content list by the content-requesting portable terminal 100, the content response unit 162 searches the memory unit 154 for the selected contents and transmits the contents to the content-requesting portable terminal 100.

The controller 151 controls the content list response unit 158, the content information response unit 160, and the content response unit 162. The controller 151 may perform the functions of the content list response unit 158, the content information response unit 160, and the content response unit 162. Although the separate units are illustrated and described for the respective functions of the controller 101, the controller 151 may perform all or some of the respective functions on behalf of the separate units.

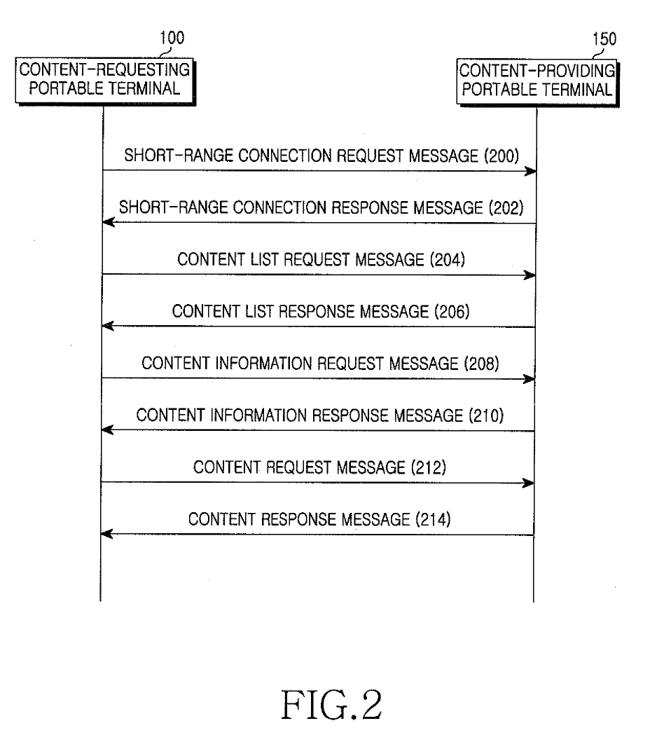

FIG. 2 is a flow diagram illustrating message flows between the content-requesting portable terminal 100 and the content-proving portable terminal 150 for transmission of contents according to an exemplary embodiment of the present invention.

Referring to FIG. 2, the content-requesting portable terminal 100 generates a short-range connection request message 200 for requesting establishment of a short-range communication, and transmits the short-range connection request message 200 to the content-providing portable terminal 150. Upon receiving the short-range connection request message 200, the content-providing portable terminal 150 transmits a short-range connection response message 202 for allowing short-range communication with the content-requesting portable terminal 100.

Upon receiving the short-range connection response message 202, the content-requesting portable terminal 100 generates a content list request message 204 for requesting a list of contents available for transmission in the content-providing portable terminal 150, and transmits the content list request message 204 to the content-providing portable terminal 150. Upon receiving the content list request message 204, the content-providing portable terminal 150 detects its transmittable contents, generates a content list, generates a content list response message 206 containing the content list, and transmits the content list response message 206 to the content-requesting portable terminal 100.

Upon receiving the content list response message 206, the content-requesting portable terminal 100 generates a content information request message 208 for requesting information about contents selected from the received content list by the user or a content request message 212 for requesting contents selected by the user, and transmits the content information request message 208 or the content request message 212 to the content-providing portable terminal 150.

Upon receiving the content information request message 208, the content-providing portable terminal 150 searches for the selected content information contained in the content information request message 208, generates a content information response message 210 containing the content information, and transmits the content information response message 210 to the content-requesting portable terminal 100. Upon receiving the content request message 212, the content-providing portable terminal 150 searches for the selected contents contained in the content request message 212, generates a content response message 214 containing the contents, and transmits the content response message 214 to the content-requesting portable terminal 100.

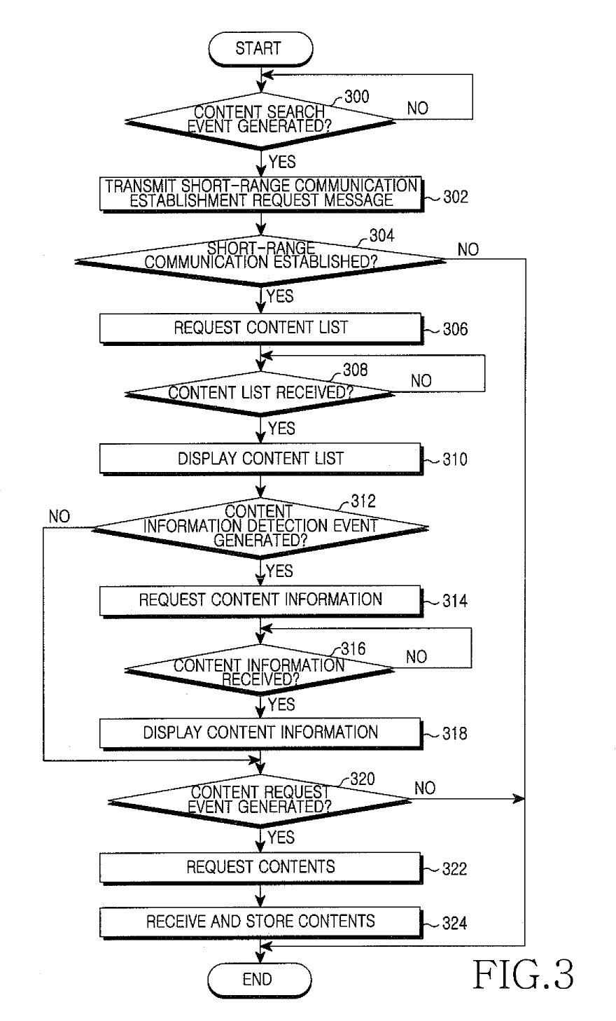

FIG. 3 is a flowchart illustrating a process for the content-requesting portable terminal 100 to search for and select contents and for receiving selected contents according to an exemplary embodiment of the present invention.

Referring to FIG. 3, in step 300, the content-requesting portable terminal 100 determines whether a content search event is generated. If the content search event is generated in step 300, the process proceeds to step 302. In step 302, the content-requesting portable terminal 100 transmits a short-range communication establishment request message to the content-providing portable terminal 150. In step 304, the content-requesting portable terminal 100 determines whether the short-range communication is established with the content-providing portable terminal 150. If the short-range communication is established in step 304, the process proceeds to step 306. In step 306, the content-requesting portable terminal 100 transmits a content list request message to the content-providing portable terminal 150 to request contents stored in the content-providing portable terminal 150. In step 308, the content-requesting portable terminal 100 determines whether a content list response message containing a content list is received from the content-providing portable terminal 150. If the content list is received in step 308, the process proceeds to step 310. In step 310, the content-requesting portable terminal 100 displays the received content list. In step 312, the content-requesting portable terminal 100 determines whether a content information detection event is generated. If the content information detection event is generated in step 312, the process proceeds to step 314, and if not, the process proceeds to step 320.

In step 314, the content-requesting portable terminal 100 transmits a content information request message containing information about contents selected by the user to the content-providing portable terminal 150. In step 316, the content-requesting portable terminal 100 receives the content information from the content-providing portable terminal 150. In step 318, the content-requesting portable terminal 100 displays the received content information.

In step 320, the content-requesting portable terminal 100 determines whether a content request event is generated. If the content request event is generated in step 320, the process proceeds to step 322, and if not, the process is ended.

In step 322, the content-requesting portable terminal 100 transmits a content request message for contents selected by the user to the content-providing portable terminal 150. In step 324, the content-requesting portable terminal 100 receives the selected contents from the content-providing portable terminal 150 and stores the received contents. Thereafter, the process is ended.

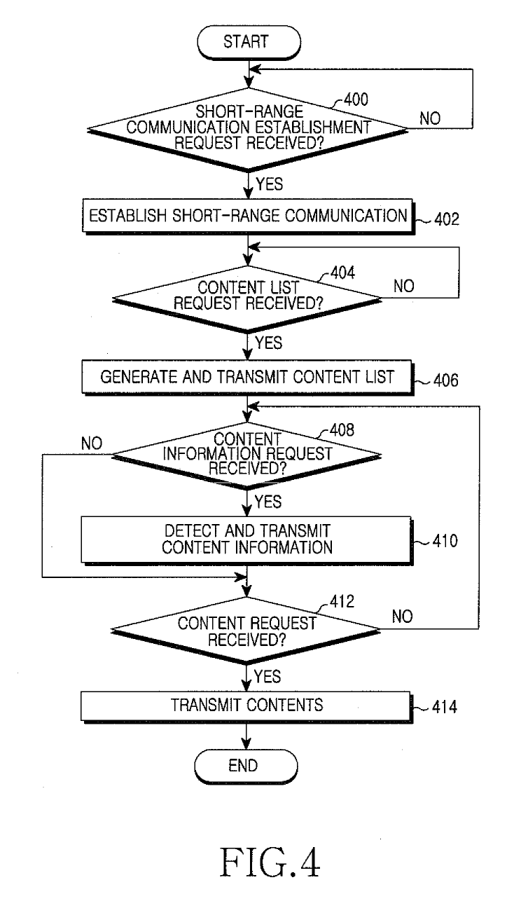

FIG. 4 is a flowchart illustrating a process for the content-providing portable terminal 150 to provide a content list and transmit selected contents according to an exemplary embodiment of the present invention.

Referring to FIG. 4, in step 400, the content-providing portable terminal 150 determines whether a short-range communication establishment request message is received from the content-requesting portable terminal 100. If the short-range communication establishment request message is received in step 400, the process proceeds to step 402. In step 402, the content-providing portable terminal 150 establishes the short-range communication, if allowed by the user. Herein, the short-range communication establishment may be performed in response to the short-range communication establishment request message from the content-requesting portable terminal 100 that is preset to allow the establishment of the short-range communication, or may be allowed directly by the user upon receipt of the short-range communication establishment request message.

In step 404, the content-providing portable terminal 150 determines whether a content list request message is received from the content-requesting portable terminal 100. If the content list request message is received in step 404, the process proceeds to step 406. In step 406, the content-providing portable terminal 150 searches for contents available for transmission, generates a content list, and transmits the content list to the content-requesting portable terminal 100. In step 408, the content-providing portable terminal 150 determines whether a content information request message is received from the content-requesting portable terminal 100. If the content information request message is received in step 408, the process proceeds to step 410, and if not, the process proceeds directly to step 412.

In step 410, the content-providing portable terminal 150 searches for basic data and metadata of the requested contents, detects the requested content information, and transmits the content information to the content-requesting portable terminal 100. In step 412, the content-providing portable terminal 150 determines whether a content request message is received from the content-requesting portable terminal 100. If the content request message is received in step 412, the process proceeds to step 414, and if not, the process returns to step 408.

In step 414, the content-providing portable terminal 150 searches for the requested contents and transmits the contents to the content-requesting portable terminal 100. Herein, the requested contents are included in the content list.

As described above, exemplary embodiments of the present invention provide an apparatus and method for transmitting contents through a short-range communication. The apparatus includes a content-requesting portable terminal and a content-providing portable terminal. The content-requesting portable terminal requests a list of contents available for transmission from the content-providing portable terminal, receives a content list from the content-providing portable terminal, selects contents from the content list, and receives the selected contents from the content-providing portable terminal. The content-providing portable terminal receives a request for transmission of one or more contents among the content list from the content-requesting portable terminal, and transmits the requested one or more contents to the content-requesting portable terminal. Thus, exemplary embodiments of the present invention make enable the provision of various content transmission methods to the user.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A system for transmitting one or more contents, the system comprising:
a content-requesting terminal for requesting a list of contents available for transmission to a content-providing terminal, for receiving the content list from the content-providing terminal, for selecting one or more contents from the content list, and for receiving the selected one or more contents from the content-providing terminal; and
the content-providing terminal for receiving a request for a content list from the content-requesting terminal, for transmitting a list of contents available for transmission to the content-requesting terminal, for receiving a request for transmitting one or more contents selected from the content list from the content-requesting terminal, and for transmitting the requested one or more contents to the content-requesting terminal.

2. The system of claim 1, wherein upon receiving the content list, the content-requesting terminal selects one or more contents requiring content information from the content list, and transmits a request for information associated with the selected one or more contents to the content-providing terminal.

3. The system of claim 2, wherein upon receiving the request for information associated with the selected one or more contents, the content-providing terminal transmits the requested content information to the content-requesting terminal.

4. The system of claim 1, wherein the contents available for transmission comprise Separate Delivery (SD) service contents that a user allows to be transmitted.

5. The system of claim 1, wherein the contents available for transmission comprise at least one of Combined Delivery (CD) service contents and non-FL (Forward Lock) contents, that a user allows to be transmitted.

6. The system of claim 1, wherein the content-requesting terminal displays the received content list and receives a user selection of one or more contents from the displayed content list.

7. The system of claim 1, wherein the content-requesting terminal stores the selected one or more contents received from the content-providing terminal.

8. The system of claim 1, wherein the content-requesting terminal and content-providing terminal communicate using a short-range communication.

9. The system of claim 1, wherein when the received one or more contents are Separate Delivery (SD) service contents, the content-requesting terminal reproduces the one or more contents by using Right Object (RO) downloaded from a Right Object (RO) management server.

10. A portable terminal for requesting one or more contents, the terminal comprising:
a short-range communication unit for establishing short-range communication with a content-providing terminal, for transmitting a content list request message to the content-providing terminal, and for receiving a content list from the content-providing terminal;
a display unit for displaying the content list; and
a content list request unit for performing at least one control operation for transmitting the content list request message for requesting a list of contents available for transmission to the content-providing terminal, and for displaying the received content list on the display unit.

11. The terminal of claim 10, wherein the short-range communication unit transmits a content information request message to the content-providing terminal and receives content information from the content-providing terminal;
the display unit displays the received content information; and
the terminal further comprises a content information request unit for performing at least one control operation for selecting one or more contents requiring information from the content list, for transmitting the content information request message requesting information associated with the selected one or more contents to the content-providing terminal, and for displaying the content information received from the content-providing terminal on the display unit.

12. The terminal of claim 10, wherein the short-range communication unit transmits a content request message to the content-providing terminal and receives one or more contents from the content-providing terminal; and
the terminal further comprises a content request unit for performing a control operation for selecting one or more contents from the content list, for transmitting the content request message requesting the selected one or more contents to the content-providing terminal, and for receiving the selected one or more contents from the content-providing terminal.

13. The terminal of claim 12, wherein when the received one or more contents are Separate Delivery (SD) service contents from the content-providing terminal, the terminal reproduces the one or more contents by using Right Object (RO) downloaded from a Right Object (RO) management server.

14. The terminal of claim 10, wherein the short-range communication unit provides the short-range communication using one of a Bluetooth communication scheme and an infrared communication scheme.

15. The terminal of claim 10, wherein the contents available for transmission comprise Separate Delivery (SD) service contents that a user allows to be transmitted.

16. The terminal of claim 10, wherein the contents available for transmission comprise at least one of Combined Delivery (CD) service contents and non-FL (Forward Lock) contents, that a user allows to be transmitted.

17. A portable terminal for providing one or more contents, the terminal comprising:
a short-range communication unit for establishing a short-range communication with a content-requesting terminal, for receiving a content list request message from the content-requesting terminal, and for transmitting a content list to the content-requesting terminal;
a memory unit for storing contents; and
a content list response unit for performing at least one control operation for receiving a request for a content list from the content-requesting terminal, for searching the memory unit for contents available for transmission, and for transmitting a list of the contents available for transmission to the content-requesting terminal.

18. The terminal of claim 17, wherein the short-range communication unit receives a content information request message from the content-requesting terminal and transmits content information to the content-requesting terminal; and
the terminal further comprises a content information response unit for performing a control operation for receiving the content information request message requesting content information from the content-requesting terminal, for searching the memory unit for information about requested one or more contents, and for transmitting the requested content information to the content-requesting terminal.

19. The terminal of claim 17, wherein the short-range communication unit receives a content request message from the content-requesting terminal and transmits one or more contents to the content-requesting terminal; and
the terminal further comprises a content response unit for performing at least one control operation for receiving the content request message requesting one or more contents from the content-requesting terminal, for searching the memory unit for requested one or more contents, and for transmitting the requested one or more contents to the content-requesting terminal.

20. The terminal of claim 17, wherein the short-range communication unit provides the short-range communication using one of a Bluetooth communication scheme and an infrared communication scheme.

21. The terminal of claim 18, wherein the content information comprises metadata of selected one or more contents.

22. The terminal of claim 17, wherein the contents available for transmission comprise Separate Delivery (SD) service contents that a user allows to be transmitted.

23. The terminal of claim 17, wherein the contents available for transmission comprise at least one of Combined Delivery (CD) service contents and non-FL (Forward Lock) contents, that a user allows to be transmitted.

24. A method for requesting one or more contents by a portable terminal, the method comprising:
establishing short-range communication with a content-providing terminal and transmitting a request for a list of contents available for transmission to the content-providing terminal; and
receiving a content list of one or more contents available for transmission from the content-providing terminal.

25. The method of claim 24, further comprising:
selecting one or more contents requiring information from the content list;
transmitting a request for information associated with the selected one or more contents to the content-providing terminal; and
receiving the selected one or more content information from the content-providing terminal.

26. The method of claim 24, further comprising:
selecting one or more contents from the content list;
transmitting a request for the selected one or more contents to the content-providing terminal; and
receiving the selected one or more contents from the content-providing terminal.

27. The method of claim 26, further comprising:when the received one or more contents are Separate Delivery (SD) service contents, reproducing the one or more contents by using Right Object (RO) downloaded from a Right Object (RO) management server.

28. The method of claim 24, wherein the short-range communication is provided using one of a Bluetooth communication scheme and an infrared communication scheme.

29. The method of claim 24, wherein the contents available for transmission comprise Separate Delivery (SD) service contents that a user allows to be transmitted.

30. The method of claim 24, wherein the contents available for transmission comprise at least one of Combined Delivery (CD) service contents and non-FL (Forward Lock) contents, that a user allows to be transmitted.

31. A method for providing one or more contents by a portable terminal, the method comprising:
establishing a short-range communication with a content-requesting terminal and receiving a request for a content list from the content-requesting terminal;
searching for contents available for transmission; and
transmitting a list of the contents available for transmission to the content-requesting terminal.

32. The method of claim 31, further comprising:
receiving a request for content information from the content-requesting terminal and searching for the requested content information; and
transmitting the requested content information to the content-requesting terminal.

33. The method of claim 31, further comprising:
receiving a request for one or more contents from the content-requesting terminal and searching for the requested one or more contents; and
transmitting the requested one or more contents to the content-requesting terminal.

34. The method of claim 31, wherein the short-range communication is provided using at least one of a Bluetooth communication scheme and an infrared communication scheme.

35. The method of claim 32, wherein the content information comprises metadata of selected one or more contents.

36. The method of claim 31, wherein the contents available for transmission comprise Separate Delivery (SD) service contents that a user allows to be transmitted.

37. The method of claim 31, wherein the contents available for transmission comprise at least one of Combined Delivery (CD) service contents and non-FL (Forward Lock) contents, that a user allows to be transmitted.
